(19) United States
(12) Patent Application Publication
(10) Pub. No.: US 2013/0054325 A1
(43) Pub. Date: Feb. 28, 2013

(54) MOBILE PLATFORM FOR REDEEMING DEALS

(71) Applicants: Jens Kjelsbak, Vaerloese (DK); Jesper Hart-Hansen, Lyngby (DK); John McElligott, Frederiksberg (DK)

(72) Inventors: Jens Kjelsbak, Vaerloese (DK); Jesper Hart-Hansen, Lyngby (DK); John McElligott, Frederiksberg (DK)

(73) Assignee: eBay Inc., San Jose, CA (US)

(21) Appl. No.: 13/585,306

(22) Filed: Aug. 14, 2012

Related U.S. Application Data
(60) Provisional application No. 61/528,612, filed on Aug. 29, 2011.

(51) Int. Cl. G06Q 30/02; G06Q 30/06

(52) U.S. Cl. 705/14.16; 705/14.23

(57) ABSTRACT

Systems and methods disclosed herein may operate to create, distribute and redeem offers on a mobile platform. In various embodiments, an indication to purchase an offer for a product or service provided by a second user may be received from a mobile device corresponding to a first user. The offer may be previously presented to the user via the mobile device. A voucher for the product or service may be transmitted to the mobile device in response to the indication. A request to redeem the voucher may be received from the mobile device. The request may include an identification code. The identification code may be compared with a shop identification code identifying the second user. An indication of redemption of the voucher may be provided to a computing device corresponding to the second user upon determining that the identification code received from the mobile device matches the shop identification code.

### CROSS REFERENCE TO RELATED APPLICATIONS

The present application claims the priority benefit of U.S. Provisional Patent Application Ser. No. 61/528,612 filed Aug. 29, 2011 and entitled “MOBILE PLATFORM FOR CREATING AND FINDING LOCAL DEALS,” of which application is incorporated herein by reference in its entirety. The present application is related to U.S. patent application Ser. No. ______entitled “MOBILE PLATFORM FOR GENERATING AND DISTRIBUTING DEALS” that was filed on the same date as the present application. The contents of U.S. patent application Ser. No. ______ are incorporated herein by reference in its entirety.

### TECHNICAL FIELD

The present application relates generally to location-based services, and, in various embodiments, to a mobile platform for creating, distributing and redeeming merchant offers.

### BACKGROUND

Sellers without an online presence are potentially disadvantaged by being hidden from a wider network of potential buyers. These sellers need to rely on local customers to discover their store, either through personal knowledge or traditional advertising channels. In the past, equipping offline sellers with an online storefront has required, among other things, computer and web design know-how and upfront costs, both of which may be cost prohibitive to an offline seller.

### BRIEF DESCRIPTION OF THE DRAWINGS

Some embodiments are illustrated by way of example and not by way of limitation, in the figures of the accompanying drawings.

FIG. 1 is a block diagram illustrating a system in a network environment for creating, distributing and redeeming deals, according to various embodiments.

FIG. 2 is a block diagram illustrating various components of a network-based publisher, according to various embodiments.

FIG. 3 is a schematic diagram illustrating a user interface of a user device to execute deal creation and distribution, according to various embodiments.

FIG. 4 is a schematic diagram illustrating a user interface of a user device to execute deal redemption, according to various embodiments.

FIG. 5 is a flow diagram illustrating a method for creating and distributing deals, according to various embodiments.

FIG. 6 is a flow diagram illustrating a method for redeeming deals, according to various embodiments.

FIG. 7 is a diagrammatic representation of a machine in the example form of a computer system, according to various embodiments.

### DETAILED DESCRIPTION

Example methods and systems to generate, distribute and redeem local merchant offers on a mobile platform are disclosed. In the following description, for purposes of explanation, numerous specific details are set forth in order to provide a thorough understanding of the present disclosure. It may be evident, however, to one skilled in the art, that the subject matter of the present disclosure may be practiced without these specific details,

Using, for example, a mobile device (e.g., a smart phone), sellers may create an offer (e.g., daily deal) for a product or service. This enables sellers who lack an online presence to make themselves available for discovery by potential buyers. Buyers may use an app to find offers proximate to their location. When a buyer discovers an offer he wishes to purchase, the buyer may purchase the offer, by paying for the offer, for example, via an mobile application using a credit card or other payment system (e.g., PayPal), receive a voucher for the product or service on his mobile device, and be able to walk into a store with the voucher on his mobile phone to redeem the voucher for the offered product or service.

The voucher may reside on the mobile device of the buyer, and be uniquely identified, for example, based on a unique identifier assigned to the voucher. When the buyer wishes to redeem the voucher, the buyer may press a redeem button on or near the voucher and be presented with a dialog box prompting him to enter an identification code for the shop. The code may be any number (e.g., four) digit code. When the buyer enters the code, at least one aspect (e.g., color) of the voucher may change, thereby indicating that the voucher has been properly redeemed or that an error has occurred in redeeming the voucher.

The voucher redemption code may be assigned to the physical location, or a particular merchant, and can be used by all users redeeming a voucher for an online purchase. When the code is entered, an indication of possession of the voucher may be sent from the mobile device of a corresponding buyer to a network-based service platform for redemption of the voucher and tracking of the status of the voucher. The platform may offer sellers analytics tool enabling them to utilize statistical information with respect to their offers, such as how many offers have been created, how many offers have been purchased, how many offers have been redeemed, and so on.

A user (e.g., a buyer) may create a deal fence in a user profile associated with the user that represents an area from which the user wishes to view deals irrespective of the user's current location. Thus, the user may view the deals from both his “home area” (e.g., a location of his place of business) and his current location, for example, identified by the location of his mobile device.

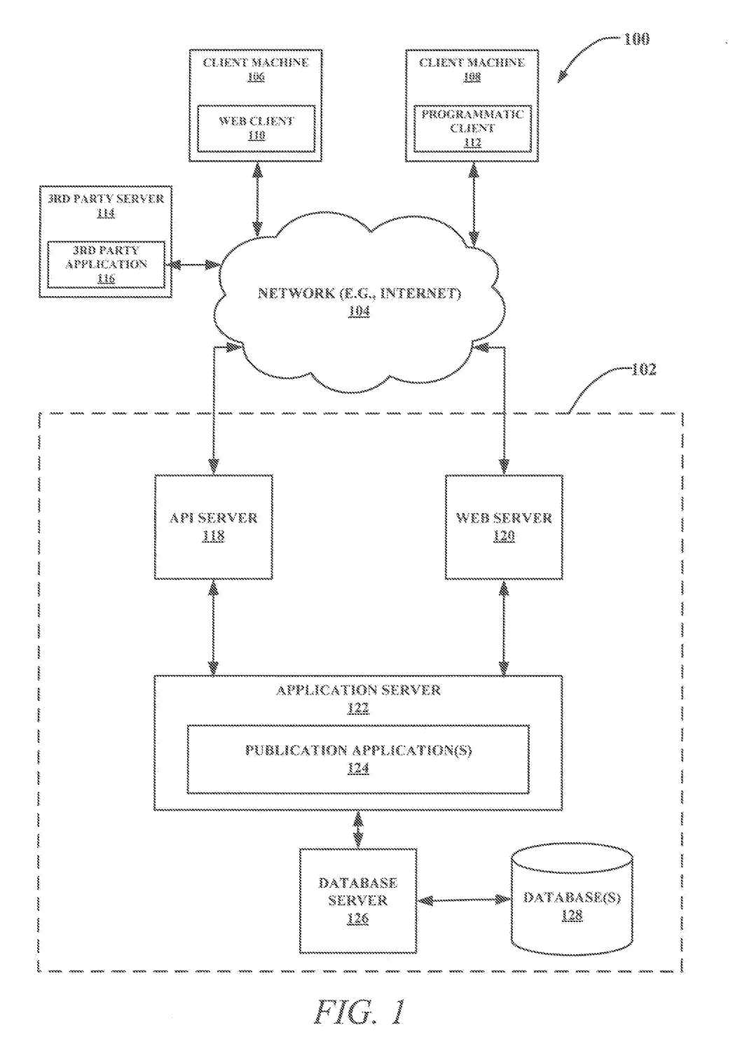

In various embodiments, an indication to purchase an offer for a product or service provided by a second user (e.g., a seller, a merchant or a sole proprietor) may be received from a mobile device corresponding to a first user (e.g., a buyer). The offer may be previously presented to the user via the mobile device. A voucher for the product or service may be transmitted to the mobile device in response to the indication. A request to redeem the voucher may be received from the mobile device. The request may include an identification code. The identification code may be compared with a shop identification code identifying the second user (e.g., the seller, merchant or sole proprietor). An indication of redemption of the voucher may be provided to a computing device corresponding to the second user upon determining that the identification code received from the mobile device matches the shop identification code. Various embodiments that incorporate these mechanisms are described below in more detail with respect to FIGS. 1-7.

FIG. 1 shows a network diagram depicting a network system 100, according to various embodiments, having a client-server architecture configured for exchanging data over a network. For example, the network system 100 may comprise a network-based publication system (or interchangeably “network-based publisher”) 102 where clients may communicate and exchange data within the network system 100. The data may pertain to various functions (e.g., selling and purchasing of items) and aspects (e.g., data describing items listed on the publication/publisher system) associated with the network system 100 and its users. In some embodiments, the data may correspond to multimedia content, audio content, or visual content. Although illustrated herein as a client-server architecture as an example, other example embodiments may include other network architectures, such as a peer-to-peer or distributed network environment.

A data exchange platform, in an example form of the network-based publisher 102, may provide server-side functionality, via a network 104 (e.g., the Internet) to one or more clients. The one or more clients may include users that utilize the network system 100 and more specifically, the network-based publisher 102, to exchange data over the network 104. These transactions may include transmitting, receiving (communicating) and processing data to, from, and regarding content and users of the network system 100. The data may include, but are not limited to, content and user data such as feedback data; user reputation values; user profiles; user attributes; product and service reviews; product, service, manufacture, and vendor recommendations and identifiers; product and service listings associated with buyers and sellers; auction bids; transaction data; and payment data, among other things.

In various embodiments, the data exchanges within the network system 100 may be dependent upon user-selected functions available through one or more client or user interfaces (UIs). The tits may be associated with a client machine, such as a client machine 106 using a web client 110. The web client 110 may be in communication with the network-based publisher 102 via a web server 120. The UIs may also be associated with a client machine 108 using a programmatic client 112, such as a client application, or a third party server 114 hosting a third party application 116. It can be appreciated in various embodiments the client machine 106, 108, or third party server 114 may be associated with a buyer, a seller, a third party electronic commerce platform, a payment service provider, or a shipping service provider, each in communication with the network-based publisher 102 and optionally each other. The buyers and sellers may be any one of individuals, merchants, or service providers, among other things.

In various embodiments, the client machine may be connected to the network 104 through which the client machine requests and accesses content from one or more content providers. The content may be broadcasted, muiticasted, streamed, or otherwise transmitted to the client device by the content providers. In some embodiments, the client machine may store content previously retrieved from a content provider and may access the stored content. In addition to the above-disclosed embodiments, in various embodiments, the client machine may be associated with a user or content viewer.

Turning specifically to the network-based publisher 102, an application program interface (API) server 118 and a web server 120 are coupled to, and provide programmatic and web interfaces respectively to, one or more application servers 122. The application servers 122 host one or more publication application(s) 124. The application servers 122 are, in turn, shown to be coupled to one or more database server(s) 126 that facilitate access to one or more database(s) 128.

In one embodiment, the web server 120 and the API server 118 communicate and receive data pertaining to listings, transactions, feedback, and content items among other things, via various user input tools. For example, the web server 120 may send and receive data to and from a toolbar or webpage on a browser application (e.g., web client 110) operating on a client machine (e.g., client machine 106). The API server 118 may send and receive data to and from an application (e.g., programmatic client 112 or third party application 116) running on another client machine (e.g., client machine 108 or third party server 114).

The publication application(s) 124 may provide a number of publisher functions and services (e.g., search, listing, content viewing, payment, etc.) to users that access the network-based publisher 102. For example, the publication application(s)124 may provide a number of services and functions to users for listing goods and/or services for sale, searching for goods and services, facilitating transactions, and reviewing and providing feedback about transactions and associated users. Additionally, the publication application(s) 124 may track and store data and metadata relating to listings, transactions, and user interactions with the network-based publisher 102. In some embodiments, the publication application(s) 124 may publish or otherwise provide access to content items stored in application servers 122 or database(s) 128 accessible to the application servers 122 and/or the database server(s) 126.

FIG. 1 also illustrates a third party application 116 that may execute on a third party server 114 and may have programmatic access to the network-based publisher 102 via the programmatic interface provided by the API server 118. For example, the third party application 116 may use information retrieved from the network-based publisher 102 to support one or more features or functions on a website hosted by the third party. The third party website may, for example, provide one or more listing, feedback, publisher or payment functions that are supported by the relevant applications of the network-based publisher 102.

While the example network system 100 of FIG. 1 employs a client-server architecture, the present disclosure is not limited to such an architecture. The example network system 100 can equally well find application in, for example, a distributed or peer-to-peer architecture system,

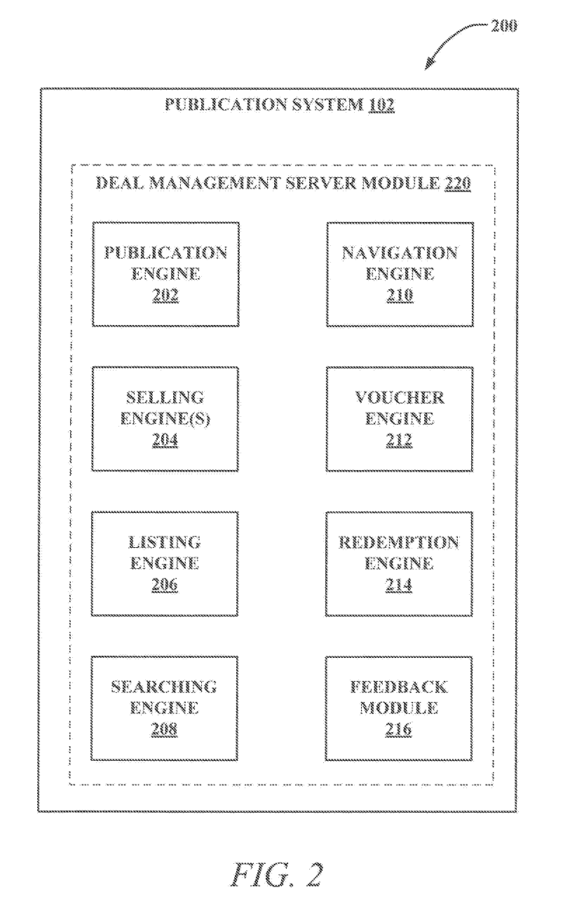

Referring now to FIG. 2, an example block diagram illustrating multiple components that, according to various embodiments, are provided within the network-based publisher 102 of the network system 100 is shown. The network-based publisher 102 may be hosted on dedicated or shared server machines (not shown) that are communicatively coupled to enable communications between the server machines. The multiple components themselves are communicatively coupled (e.g., via appropriate interfaces), either directly or indirectly, to each other and to various data sources, to allow information to be passed between the components or to allow the components to share and access common data. Furthermore, the components may access the one or more database(s) 128 via the one or more database servers 126, both shown in FIG. 1.

In one embodiment, the network-based publisher 102 comprises a network-based marketplace and provides a number of publishing, listing, and price-setting mechanisms whereby a seller (e.g., business or consumer) may list (or publish information concerning) goods or services for sale, a buyer can search for, express interest in, or indicate a desire to purchase such goods or services, and a price can be set for a transaction pertaining to the goods or services. In some embodiments, a buyer may also post listings containing items the buyer is looking to purchase. Sellers may view listings posted by buyers and may provide the item to the buyer if possible, by, in some embodiments, providing the item to the buyer directly or by redirecting the buyer to a listing of the requested item that has been posted by the seller.

To this end, in various embodiments, the network-based publisher 102 may comprise a deal management server module 220 that in turn may comprise at least one publication engine 202 and one or more selling engines 204. The publication engine 202 may publish information, such as item listings or product description pages, on the network-based publisher 102. In some embodiments, the selling engines 204 may comprise one or more fixed-price engines that support fixed-price listing and price setting mechanisms and one or more auction engines that support auction-format listing and price setting mechanisms (e.g., English, Dutch, Chinese, Double, Reverse auctions, etc.). The various auction engines may also provide a number of features in support of these auction-format listings, such as a reserve price feature whereby a seller may specify a reserve price in connection with a listing and a proxy-bidding feature whereby a bidder may invoke automated proxy bidding. The selling engines 204 may further comprise one or more deal engines that support merchant-generated offers for products and services.

A listing engine 206 allows sellers to conveniently author listings of items or authors to author publications. In one embodiment, the listings pertain to goods or services that a user (e.g., a seller) wishes to transact via the network-based publisher 102. Each good or service is associated with a particular category. The listing engine 206 may receive listing data such as title, description, and aspect name/value pairs. Furthermore, each listing for a good or service may be assigned an item identifier. In other embodiments, a user may create a listing that is an advertisement or other form of information publication. The listing information may then be stored to one or more storage devices coupled to the network-based publisher 102 (e.g., databases 128). Listings also may comprise product description pages that display a product and information (e.g., product title, specifications, and reviews) associated with the product. In some embodiments, the product description page may include an aggregation of item listings that correspond to the product described on the product description page.

The listing engine 206 also may allow buyers to conveniently author listings or requests for items desired to be purchased. In some embodiments, the listings may pertain to goods or services that a user (e.g., a buyer) wishes to transact via the network-based publisher 102. Each good or service is associated with a particular category. The listing engine 206 may receive as much or as little listing data, such as title, description, and aspect name/value pairs, that the buyer is aware of about the requested item. In some embodiments, the listing engine 206 may parse the buyer's submitted item information and may complete incomplete portions of the listing. For example, if the buyer provides a brief description of a requested item, the listing engine 206 may parse the description, extract key terms and use those terms to make a determination of the identity of the item. Using the determined item identity, the listing engine 206 may retrieve additional item details for inclusion in the buyer item request. In some embodiments, the listing engine 206 may assign an item identifier to each listing for a good or service.

In some embodiments, the listing engine 206 allows sellers to generate offers for discounts on products or services. The listing engine 206 may receive listing data, such as the product or service being offered, a price and/or discount for the product or service, a time period for which the offer is valid, and so forth. The listing data may include a code that identifies the seller (e.g., human seller, retailer, store) submitting the offer. In some embodiments, the listing engine 206 permits sellers to generate offers from the sellers' mobile devices. The generated offers may be uploaded to the network-based publisher 102 for storage and tracking.

Searching the network-based publisher 102 is facilitated by a searching engine 208. For example, the searching engine 208 enables keyword queries of listings published via the network-based publisher 102. In example embodiments, the searching engine 208 receives the keyword queries from a device of a user and conducts a review of the storage device storing the listing information. The review will enable compilation of a result set of listings that may be sorted and returned to the client device (e.g., client device 106) of the user. The searching engine 208 may record the query (e,g., keywords) and any subsequent user actions and behaviors (e.g., navigations).

The searching engine 208 also may perform a search based on the location of the user. A user may access the searching engine 208 via a mobile device and generate a search query. Using the search query and the user's location, the searching engine 208 may return relevant search results for products, services, offers, auctions, and so forth to the user. The searching engine 208 may identify relevant search results both in a list form and graphically on a map. Selection of a graphical indicator on the map may provide additional details regarding the selected search result. In some embodiments, the user may specify, as part of the search query, a radius or distance from the user's current location to limit search results.

In a further example, a navigation engine 210 allows users to navigate through various categories, catalogs, or inventory data structures according to which listings may be classified within the network-based publisher 102. For example, the navigation engine 210 allows a user to successively navigate down a category tree comprising a hierarchy of categories until a particular set of listings is reached. Various other navigation applications within the navigation engine 210 may be provided to supplement the browsing and searching applications 208. The navigation engine 210 may record the various user actions (e.g., clicks) performed by the user in order to navigate down the category tree.

When a user selects a listing, such as an offer, to purchase, a voucher engine 212 generates a voucher. In some embodiments, the voucher may reside on the mobile device of the buyer. In some embodiments, the voucher may include an identifier, which may be a unique number. If the voucher engine 212 is located within an application executing on the mobile device, the generated voucher may be sent to the network-based publisher 102 via a network (e.g., the network 104) for storage. If the voucher engine 212 is located within the network-based publisher 102, the generated voucher may be transmitted to the user's mobile device for storage thereon.

When a user desires to redeem the voucher for the offered product or service, the user may travel to the location of the seller (e.g., a store) and present the voucher to the seller for redemption. As part of the redemption process, a redemption engine 214 may generate a user interface that prompts the user to enter a code for the seller. In some embodiments, the seller code may be a fixed code that is separate from the voucher identifier. The entered seller code and the voucher identifier may be transmitted to the network-based publisher 102 for verification and the redemption of the voucher may be tracked. The network-based publisher 102 also may transmit a voucher acceptance message to the seller indicating that the voucher that the buyer is presenting is authentic. The seller in turn may provide the buyer with the offered product or service. In some embodiments, the redemption process may occur via mobile devices possessed by the buyer and the seller, thereby eliminating the need for paper or hard copies of documents, such as vouchers and receipts.

A feedback module 216 may reside within the application executing on the mobile device. The feedback module 216 may enable a user to generate feedback for any portion of the application, such as the listing process, the voucher generation process, the redemption process, or any user interface or functionality presented in the application. Using a touch gesture recognized by the application, the feedback module 216 may present a user with a dialog box for entering feedback about a particular aspect of the application. For example, a user may perform a recognized touch gesture using three fingers that are moved in an upward motion on a multi-touch interface. Once entered, the feedback module 216 may perform a screen capture of the user interface containing the feedback dialog box and may transmit the screen capture image in an e-mail to the network-based publisher 102. The image of the feedback may be tagged with metadata describing the circumstances of the feedback, such as a time stamp, a location of the user, an aspect of the application for which feedback is being left, and so forth. Thus, the user is no longer restricted to leaving feedback only within designated areas of the application or only in response to a certain sequence of events occurring (e,g., at the end of a transaction).

In some embodiments, one or more of the engines and modules described with reference to FIG. 2 may be implemented or executed by one or more processors. Additionally, in some embodiments, one or more of the engines or modules described with reference to FIG. 2 may comprise one or more modules to carry out specific operations or tasks for the engine(s), and yet maintain the same functionality. In some embodiments, some or all of the engines and modules described with reference to FIG. 2 may reside in the application executing on the client device, while in other embodiments some or all of the engines and modules of FIG. 2 may reside on one or more servers of the network-based publisher 102. In addition, the engines and modules of FIG, 2 may have separate utility and application outside of the network-based publisher 102. For example, the feedback module 216 may be implemented in any application, user interface, or web site.

Although the various components of the network-based publisher 102 have been discussed in terms of a variety of engines and modules, one of skill in the art will recognize that many of the items can be combined or organized in other ways. Furthermore, not all components of the network-based publisher 102 have been included in FIG. 2. In general, components, protocols, structures, and techniques not directly related to functions of example embodiments (e.g., dispute resolution engine, loyalty promotion engine, reputation engines, listing management engines, account engine) have not been shown or discussed in detail. The description given herein simply provides a variety of example embodiments to aid the reader in an understanding of the systems and methods used herein.

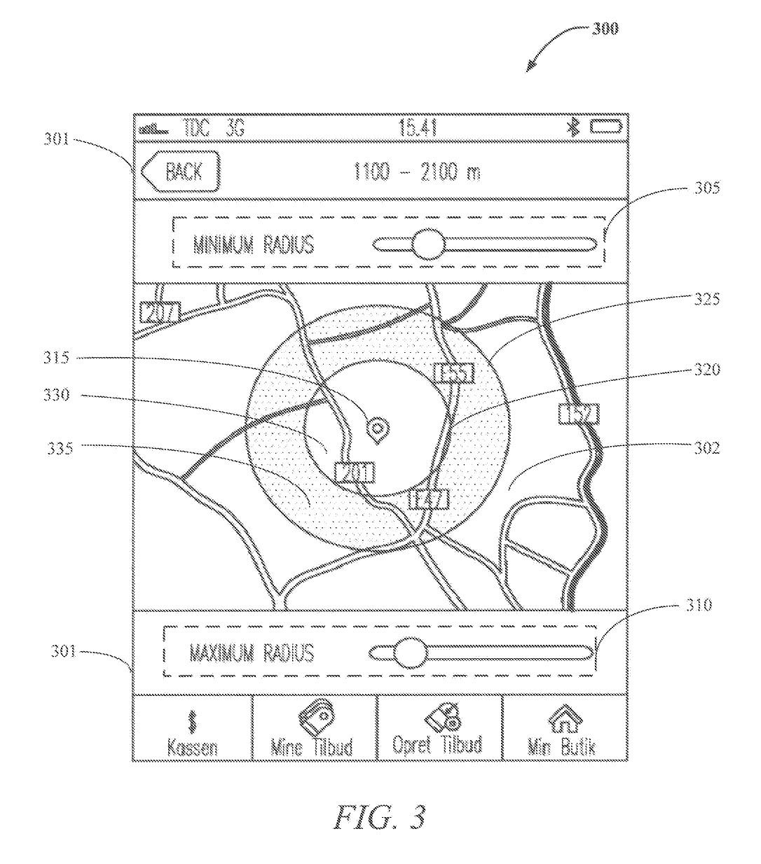

FIG. 3 shows a schematic diagram illustrating a user interface 300 of a user device (e.g., the client machine 106, 108) to execute deal creation and distribution, according to various embodiments. For example, using the user interface 300, a user (e.g., a show owner) may create a (e.g., flash) deal on his mobile device such that the deal may be discovered by users, via their mobile devices in a radius of x meters from his shop to x+ meters from his shop (e.g., in an area shaped like a donut ring as shown in FIG. 3). The (e.g., donut ring shaped) area identified by the two radii is the area where relevant users may receive, via their mobile devices, push messages about the deal. This allows attracting foot traffic to the shop in an area that does not include the very closest vicinity of his shop. However, the area within the inner circle may be set as a “dead zone” (e.g., exclusion zone) around the shop of the user where the (e.g., flash) deal is not for sale, protecting the shop owner from revenue cannibalization (e.g., “market canabilization”) by mobile users already in or near the shop.

In various embodiments, referring to FIG. 3, the user interface may comprise a non-map area 301 and a map area 302. The non-map area 301 may include one or more interfaces, such as a first geographical zone identifier (e.g., “Minimum radius”) 305 and a second geographical zone identifier (e.g., “Maximum radius”) 310. Each of the geographical zone identifiers 305, 310 may be used to define a geographical area where a deal for a product or service generated by a user of the user interface 300 may be distributed according to a distribution policy associated with a corresponding geographical zone.

For example, referring to FIG. 3, the user may set, using the first geographical zone identifier 305, a first radius to define a boundary line 320 of an exclusion zone (e.g., an inner circle) such that the deal for the product or service may not be distributed to mobile devices located in the (e.g., circular) area 330 inside the boundary line 320 of the exclusion zone. Also, the user may set, using the second geographical zone identifier 310, a second radius to define a boundary line 325 of an inclusion zone (e.g., an outer circle) such that the deal may be distributed to the mobile device located in the area (e.g., the shaded area shaped in a donut ring) 335 between the two boundary lines, but not to the mobile devices located within the area 330 defined by the boundary line 320. At least one of the first and second boundary lines (e.g., a first and second circumference of a corresponding circle) may be determined based on a reference point 315, such as a location of the user device displaying user interface 300, a location of a store of the user where the product or service for the deal is provided, or a user selected location.

In various embodiments, at least one of the boundary lines 320, 325 may be dynamically changed (e.g., enlarged or narrowed) based on statistical information with respect to distribution, purchase or redemption of the deals. In one embodiment, various information may be monitored regarding status of a given deal, such as the number of mobile devices to which the deal has been distributed to, the number of mobile devices from which the deal has been purchased, the number of mobile devices from which a voucher for a product or service offered by the deal has been redeemed, and so on. At least a portion of the information may be tracked within a specified time frame, such as one or more hours, days, weeks or months from the creation of the deal.

For example, at the end of the specified time frame (e.g., one or more hours, days, weeks or months), it may be determined whether the number of the redemptions of the deal or the ratio of the redemptions to the generations or purchases of the deal has exceeded a first specified threshold value (e.g., minimum sales volume) indicating less sales than expected, or a second specified threshold value (e.g., maximum sales volume) indicating more sales than desired (e.g., at a discounted price offered by the deal). Based on such information, at least one of the boundary line 320 of the exclusion zone or the boundary line 325 of the inclusion zone may be dynamically adjusted, for example, to increase or decrease the possibility of the deal being distributed, purchased or redeemed among the mobile devices near the place of business for the product or service offered by the deal.

Although the user interface 300 in FIG. 3 is shown to include two (e.g., exclusion and inclusion) zones and two separate zone identifiers (e.g., the first and second geographical zone identifier 305, 310) to define a corresponding one of the two zones, more than two zones may be defined, and less or more zone identifiers may be employed to define the zones. The user interface 300 may comprise other menus to define other terms and conditions for the deal, such as a title, an identification code, an expiration date, a price of the deal, and so on. Although the areas of the exclusion and inclusion zones in FIG. 3 are shown to be a circular area, at least one zone may be defined as another geographical shape. In such a case, for example, at least one zone may be determined based on a boundary line of an administrative district, using a zip code, a district name, or a random line drawn by the user on the map area 302 of the user interface.

In various embodiments, at least one of the zones (e.g., the exclusion zone) to be displayed on the user interface 300 may be determined at least in part based on location information of a point of interest selected by the user, such as a school, a kindergarten, a nursery home and so on, for example, to avoid distribution of deals for certain products or services (e.g., alcoholic beverages or adult toys) to an area close (e.g., within 0.5 mile, 1 mile, or 2 miles) to the point of interest. For example, in certain embodiments, the user interface 300 may enable a user to submit a list of locations to be excluded within an inclusion zone. In this embodiment, a user running an alcohol ad campaign could provide a list of location where it would be inappropriate to advertise alcoholic beverages. The list of locations could also include (or be accompanied by) exclusion radii for each location on the list of locations. Alternatively, the user can set a default radius for excluded points of interest in a list of locations.

In various embodiments, an apparatus (e.g., the network-based publication system 102) may comprise: one or more processors to execute a deal management module, such as one or more of the engines 202-216, including the listing engine 206 and/or the redemption engine 214, of the network-based publication system 102 in FIG, 2. The deal management module may be configured to: receive, from a computing device corresponding to a merchant, a first set of information describing terms of an offer for a product or service provided by the merchant, and a second set of information identifying a first zone and a second zone; generate the offer for the product or service based, at least in part, on the first set of information; generate an exclusion zone and an inclusion zone based on the information identifying the first zone and the second zone, respectively, the exclusion zone overlapping at least a portion of the inclusion zone; and selectively distribute the offer, across a network, to a first plurality of mobile devices located outside the exclusion zone and within the inclusion zone such that the offer is invisible to a second plurality of mobile devices located within both the exclusion and inclusion zones.

In various embodiments, the deal management module may be configured to define an outer boundary of each of the exclusion and inclusion zones at least in a similar geometric shape.

In various embodiments, the deal management module may be configured to define an outer boundary, for the exclusion zone in a first geometric shape, and an outer boundary for the inclusion zone in a second geometric shape.

In various embodiments, the deal management module may be configured to generate the exclusion and inclusion zones in relation to a location of interest to the merchant.

In various embodiments, the deal management module may be configured to select, as the location of interest, a physical business location operated by the merchant where the product or service is provided.

In various embodiments, the deal management module may be configured to select, as the location of interest, a physical business location operated by another merchant where an item identical or related to the product or service is provided.

In various embodiments, the deal management module may be configured to select, as the location of interest, a location where the computing device is physically located.

In various embodiments, the deal management module may be configured to monitor the number of the mobile devices where the offer is active, and to automatically adjust a boundary of at least one of the exclusion zone or the inclusion zone based, at least in part, on the number.

In various embodiments, the deal management module may be configured to monitor the number of mobile devices where the offer is purchased, and to automatically adjust a boundary of at least one of the exclusion zone or the inclusion zone based at least in part on the number.

In various embodiments, the deal management module may be configured to monitor a period of time left for the offer to remain active, and to automatically adjust a boundary of at least one of the exclusion zone or the inclusion zone based, at least in part, on the period of time left. Other embodiments are possible.

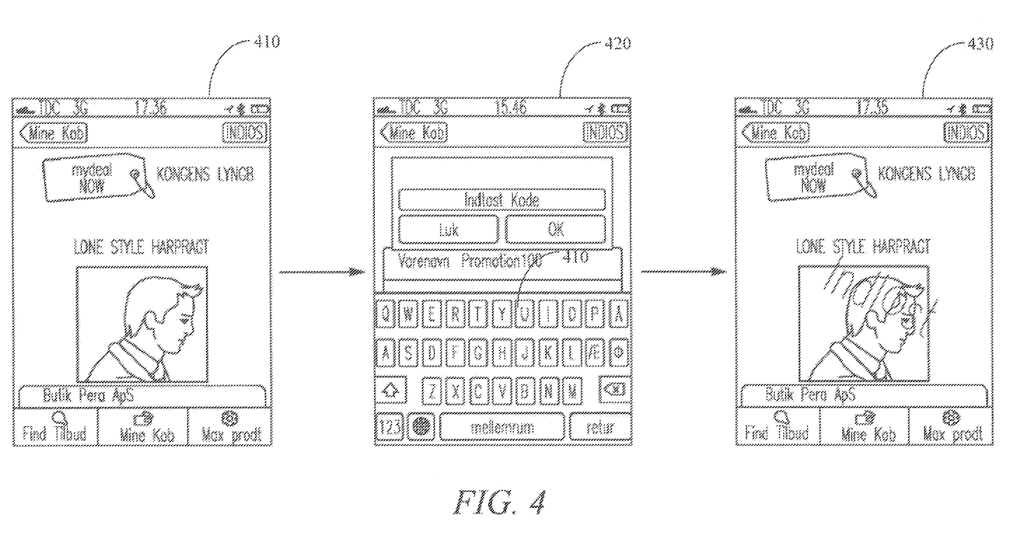

FIG. 4 shows a schematic diagram illustrating a user interface 400 of a user device (e.g., the client machine 106, 108) to execute deal redemption, according to various embodiments. Using the user interface 400, a user (e.g., a buyer or customer) may have a voucher for a product or service offered by a relevant deal redeemed in a shop without the need of any devices in the shop other than his mobile device where the voucher has been previously received upon purchase of the (relevant) deal. For example, when the user with the (purchased) voucher residing on his mobile device walks into the shop to redeem the voucher in exchange for the product or service, the user may push a redeem button displayed on or near the voucher. The voucher may be redeemed, for example, when the user types, via his mobile device, an verification code for the voucher, such as a public identification code of the shop (e.g., a XXXX digit number) generated and issued to the shop upon registration of the shop to the deal generation, distribution and redemption service. This may trigger a self-service redemption of the voucher upon determination that the verification code matches an existing shop code stored in a storage device associated with a network-based transaction facility (e.g., the network-based publisher 102) providing the deal generation, distribution and redemption service.

In various embodiments, for example, FIG. 4 shows three images 410-430 of the user interface 400 for the deal redemption in various embodiments. The first image (left) shows a voucher 4110 of a product or service. In various embodiments, the voucher 410 may be generated using a relevant network-based transaction facility (e,g., the network-based publisher 102) in response to a request from a user (e.g., a buyer) of the user device to purchase a deal for the product or service. As described above, for example, with respect to FIG. 3, the deal may be generated based on the terms and conditions provided by a different user (e.g., a seller or merchant of the product or service) and distributed to the user device corresponding to the user (e.g., the buyer) according to one or more deal distribution policies associated with a corresponding location of the user device.

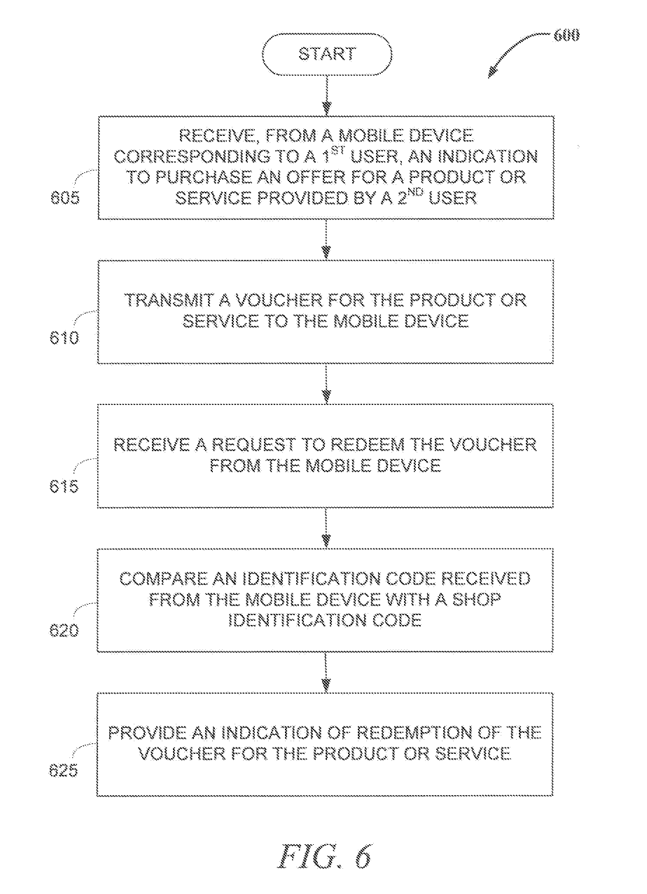

The second image (middle) in FIG. 4 shows a shop identification code providing menu 420 by which the user may enter an identification code for the seller or his shop to be transmitted to a relevant network-based transaction facility (e.g., the network-based publisher 102) along with a request to redeem the voucher 410. As explained in more detail below, for example, with respect to FIG. 6, when receiving the identification code, the relevant network-based transaction facility may compare the identification code with one or more existing shop identification codes with each identification code identifying a seller (e.g., a merchant) who generated the deal or her or his shop in which the product or service is provided, in order to verify the redemption request. When the verification is done, an indication 430 (e.g., red word or stamp) showing whether the voucher 410 has been properly redeemed or not (e,g., error) may be generated, for example, by the relevant network-based transaction facility and presented to the user device, as shown in the third image (right) in FIG. 4. In various embodiments, other type of information, such as a voice message, a musical note or a beep sound, may be used as at least part of the indication 430.

In various embodiments, an apparatus (e.g., the network-based publication system 102) may comprise one or more processors to execute the deal management module, such as one or more of the engines 202-216, including the listing engine 206 and/or the redemption engine 214, in FIG. 2. The deal management module may be configured to: receive, from a mobile device corresponding to a first user, an indication to purchase an offer for a product or service provided by a second user, the offer being previously presented to the user via the mobile device; transmit a voucher for the product or service to the mobile device in response to the indication to purchase the offer; receive a request to redeem the voucher from the mobile device, the request including an identification code; compare the identification code received from the mobile device with a shop identification code identifying the second user; and provide an indication of redemption of the voucher to a computing device corresponding to the second user based on determining that the identification code received from the mobile device matches the shop identification code.

In various embodiments, the deal management module may be configured to: receive, from the computing device, information describing terms of the offer for the product or service; generate the offer based, at least in part, on the information describing the terms; and distribute the offer to a plurality of mobile devices including the mobile device based on determining that the mobile devices are located within a specified geographical zone.

In various embodiments, the deal management module may be configured to: receive, from the computing device, first zone information identifying a first geographical area, and second zone information identifying a second geographical area; generate an exclusion zone and an inclusion zone based, at least in part, on the first zone information and the second zone information, respectively, such that the exclusion zone overlaps at least a portion of the inclusion zone; and designate, as the specified geographical zone, an area located outside the exclusion zone and within the inclusion zone.

In various embodiments, the deal management module may be configured to: identify a geographical location of the mobile device based, at least in part, on location information received from the mobile device; and to provide the mobile device with a plurality of oilers including the offer available at the geographical location.

In various embodiments, the deal management module may be configured to cause the plurality of offers to be presented, via the mobile device, as sorted based, at least in part, on a category of the product or service associated with a corresponding offer of the offers, or a distance between the geographical location of the mobile device and a physical business location that provides the corresponding offer.

In various embodiments, the deal management module may be configured to assign, as the shop identification code, a unique identification number associated with a physical business location operated by the second user.

In various embodiments, the deal management module may be configured to trigger, based on matching the identification code received from the mobile device to the shop identification code, transfer of a fee associated with the offer from a first account corresponding to the first user to a second account corresponding to the second user.

In various embodiments, the deal management module may be configured to trigger the transfer of the fee associated with the offer by communicating transaction details to a third-party payment system.

In various embodiments, the deal management module may be configure to invalidate the voucher upon expiration of a time period specified in the offer.

In various embodiments, the deal management module may be configured to provide the computing device with status information for one or more vouchers including the voucher for a corresponding offer generated by the second user, the status information including at least one of first information indicating whether the voucher has been redeemed, or second information indicating when the voucher was redeemed via the mobile device of a user who purchased the offer. Yet other embodiments are possible.

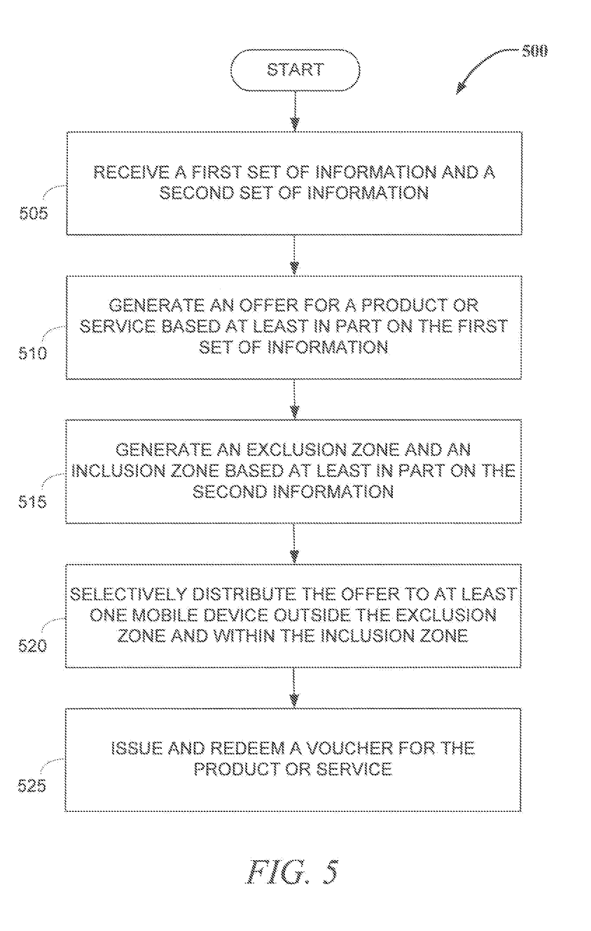

FIG. 5 shows methods 500 for generating and distributing deals, according to various embodiments. The methods 500 may be implemented, for example, using the system 100 and/or apparatus 102, 106, 108, 114 shown in FIG. 1, among others. In one embodiment, for example, some or all activities described herein with respect to the methods 500 may be performed as a function of the deal management module that may comprise one or more engines 202-216, such as the listing engine 206 and/or the redemption engine 214, of the network-based publication system 102.

In various embodiments, the methods 500 may begin, at block 505, with receiving, from a computing device (e,g., the client machine 106, 108) corresponding to a user (e.g., a seller or a merchant), a first set of information describing terms of an offer for a product or service provided by the user, and a second set of information identifying a first zone and a second zone. In one embodiment, for example, the information may be received, for example, at the application server 122 of the network-based publication system 102 in FIG. 1.

In various embodiments, at block 510, the offer for the product or service may be generated based, at least in part, on the first set of information.

In various embodiments, at block 515, an exclusion zone and an inclusion zone may be generated based, at least in part, on the information identifying the first zone and the second zone, respectively. In one embodiment, the exclusion zone may overlap at least a portion of the inclusion zone. In another embodiment, multiple exclusion zones may be generated based, at least in part, on information identifying multiple additional zones. In yet another embodiment, multiple exclusion and multiple inclusion zones may be generated based on information received from a user.

In various embodiments, at block 520, the offer for the product or service may be selectively distributed, across a network, to a first plurality of mobile devices located outside the exclusion zone and within the inclusion zone such that the offer may be invisible to a second plurality of mobile devices located within both the exclusion and inclusion zones.

In various embodiments, generating the exclusion zone and the inclusion zone may comprise centering the exclusion and inclusion zones around a physical business location operated by the merchant.

In various embodiments, generating the exclusion zone and the inclusion zone may comprise encompassing the entire exclusion zone within the inclusion zone.

In various embodiments, generating the exclusion zone and the inclusion zone may comprise leaving at least a portion of the exclusion zone outside the inclusion zone.

In various embodiments, generating the exclusion zone and the inclusion zone may comprise defining an outer boundary for a corresponding one of the exclusion or inclusion zones based on at least one of a physical landmark, an administrative district, a zip code, a radius from a user-chosen location, or a user-drawn line on a map.

In various embodiments, generating the exclusion zone and the inclusion zone may comprise assigning the exclusion zone a first color, and the inclusion zone a second color, for display on the computing device.

In various embodiments, selectively distributing the offer may comprise refraining from delivering the offer to the second plurality of mobile devices.

In various embodiments, selectively distributing the offer may comprise delivering the offer to the second plurality of mobile devices such that the offer remains deactivated and invisible to the second plurality of mobile devices, at least for a period of time.

In various embodiments, the exclusion zone may expire after a certain time period (e.g., an expiration time). For example, in one embodiment, selectively distributing the offer may comprise refraining from delivering the offer to the second plurality of mobile devices located within both the exclusion and inclusion zones at least for a period of time, and automatically delivering the offer to the second plurality of mobile devices after the period of time. In another embodiments, the period of time (e.g., the expiration time) for which the offer may not be delivered to the second plurality of mobile devices may be determined based on at least one of a user input or statistics related to purchase of the offer and/or redemption of its associated voucher among the first plurality of mobile devices. For example, in one embodiment, the period of time (e.g., the expiration time) for the exclusion zone may be extended or shortened if the number of purchases and/or redemptions of the offer (or its associated voucher) exceeds or falls short of a predetermined threshold value.

In various embodiments, at block 525, a voucher for the product or service may be generated upon receiving an indication of purchase of the offer, and the voucher may be redeemed in exchange of the product of service, for example, as described in detail with respect to FIG. 6. Other embodiments are possible.

FIG. 6 shows methods 600 for redeeming deals, according to various embodiments. Similarly to the methods 500, the methods 600 may be implemented, for example, using the system 100 and/or apparatus 102, 106, 108, 114 shown in FIG. 1, among others. In one embodiment, for example, some or all activities described herein may be performed as a function of the deal management module that may comprise one or more engines 202-216, such as the listing engine 206 and/or the redemption engine 214, of the network-based publication system 102.

In various embodiments, the methods 600 may begin, at block 605, with receiving, from a mobile device (e.g., the client device 106, 108) corresponding to a first user (e.g., a buyer), an indication to purchase an offer for a product or service provided by a second user (e.g., a seller, a merchant or a sole proprietor). The offer may be previously presented to the user via the mobile device. In one embodiment, for example, the offer may be generated and/or distributed to a plurality of mobile devices including one corresponding to the first user using the methods 500 described above. In one embodiment, for example, the indication to purchase the offer may be received, for example, at the application server 122 of the network-based publication system 102 in FIG. 1.

In various embodiments, at block 610, a voucher for the product or service may be generated and transmitted to the mobile device in response to the indication to purchase the offer.

In various embodiments, at block 615, a request to redeem the voucher may be received from the mobile device. In one embodiment, for example, the request may include an identification code.

In various embodiments, at block 620, the identification code received from the mobile device may be compared with a shop identification code identifying the second user (e,g., the seller, merchant or sole proprietor). In one embodiment, for example, the shop identification code may be retrieved from a storage device associated with the network-based publication system 102, such as the database(s) 128.

in various embodiments, at block 625, an indication of redemption of the voucher for the product of service may be provided to a computing device corresponding to the second user based on determining that the identification code received from the mobile device matches the shop identification code.

In various embodiments, receiving the request to redeem may comprise receiving, as the identification code, a non-encrypted string of at least one of a letter, a number or a symbol from the mobile device.

In various embodiments, receiving the request to redeem may comprise receiving, as the identification code, information captured via at least one of a bar code reader, a QR (Quick Response) code reader or a RFID (radio-frequency identification) reader associated with the mobile device.

In various embodiments, comparing the identification code (received from the mobile device corresponding to the first user) with the shop identification code, may comprise verifying whether the shop identification code has been assigned to a vendor whose physical business location does not have a fixed geographical address.

In various embodiments, comparing may comprise determining whether the shop identification code matches a mobile phone number of the second user (e.g., the seller, merchant or sole proprietor).

In various embodiments, the methods 600 may further comprise triggering, based on matching the identification code received from the mobile device to the shop identification code, transfer of a fee associated with the offer from a first account corresponding to the first user to a second account corresponding to the second user. In one embodiment, for example, at least one of the first and second account may be associated with a third party payment system, such as PayPal or another financial institution.

In various embodiments, the methods 600 may further comprise: receiving, from the computing device, information describing terms of the over for the product or service; generating the offer based, at least in part, on the information describing the terms; and distributing the offer to a plurality of mobile devices including the mobile device based on determining that the mobile devices are located within a specified geographical zone.

In various embodiments, distributing the offer to the plurality of mobile devices may comprise: receiving, from the computing device, first zone information identifying a first geographical area, and second zone information identifying a second geographical area; generating an exclusion zone and an inclusion zone based, at least in part, on the first zone information and the second zone information, respectively, such that the exclusion zone overlaps at least a portion of the inclusion zone; and designating, as the specified geographical zone, an area located outside the exclusion zone and within the inclusion zone.

In various embodiments, distributing the offer to the plurality of mobile devices may comprise refraining from distributing the offer to one or more of the plurality of mobile devices located within both the exclusion zone and the inclusion zone. Other embodiments are possible.

The methods 500 and/or 600 may be performed by processing logic that may comprise hardware (e.g., dedicated logic, programmable logic, microcode, etc.), such as at least one processor, software (such as run on a general purpose computing system or a dedicated machine), firmware, or any combination of these. It is noted that although the methods 500 and 600 are explained above with respect to a server machine, such as the network-based publisher 102 including the application server 122, and/or client machines 106, 108 in FIG. 1, those skilled in the art will recognize that the methods 500 and 600 may be performed by other systems and/or devices that provide substantially the same functionalities as the server machine, such as the network-based publisher 102, and/or the client machines 106, 108.

Although only some activities are described with respect to FIGS. 5 and 6, the methods 500 and 600, according to various embodiments, may perform other activities, such as operations performed by the client machine 106, 108, the API server 118, the web server 120, the application server 122, the database server 126 and/or the third party server 114 in FIG. 1, in addition to and/or in alternative to the activities described with respect to FIGS. 5 and 6.

The methods 500 and 600 described herein do not have to be executed in the order described, or in any particular order. Moreover, various activities described with respect to the methods 500 and 600 identified herein may be executed in repetitive, serial, heuristic, parallel fashion or any combinations thereof. The individual activities of the methods 500 and 600 shown in FIGS. 5 and 6 may also be combined with each other and/or substituted, one for another, in various ways. Information, including parameters, commands, operands, and other data, may be sent and received between corresponding modules or elements in the form of one or more carrier waves. Thus, many other embodiments may be realized.

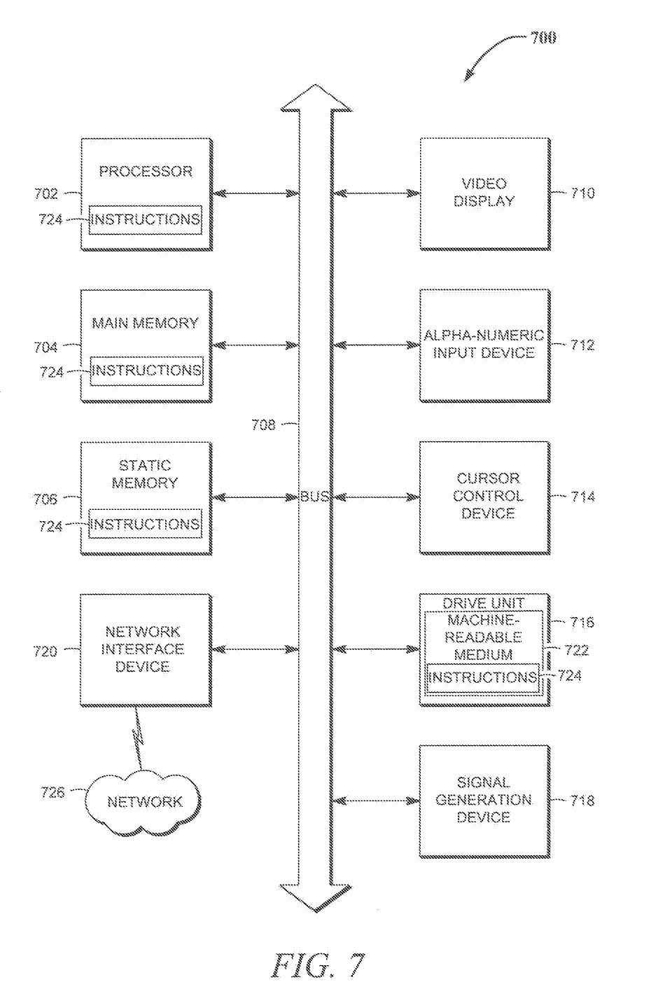

In various embodiments, the methods 500 and 600 shown in FIGS. 5 and 6 may be implemented in various devices, as well as in a machine-readable medium, such as a storage device, where the methods 500 and 600 are adapted to be executed by one or more processors. Further details of such embodiments are described below with respect to FIG. 7.

FIG. 7 is a diagrammatic representation of a machine (e,g., the network-based publisher 102 (or any server machine included therein, such as the API server 118, the web server 120, the application server 122 or the database server 126), the client machines 106, 108 or the third party server 114) in the example form of a computer system 700, according to various embodiments within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a personal digital assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700, comprising an article of manufacture, may include a processor 702 (e.g., a central processing unit (CPU) a graphics processing unit (GPU) or both), a main memory 704 and a static memory 606, which communicate with each other via a bus 708. The computer system 700 may further include a video display unit 710 (e.g., a liquid crystal display (LCD) or a cathode ray tube (CRT)). The computer system 700 also includes an alphanumeric input device 712 (e.g., a keyboard), a cursor control device 714 (e.g., a mouse), a disk drive unit 716, a signal generation device 718 (e.g., a speaker or an antenna) and a network interface device 720.

The disk drive unit 716 may include a machine-readable medium 722 on which is stored one or more sets of instructions 724 (e.g., software) embodying any one or more of the methodologies or functions described herein. The instructions 724 may also reside, completely or at least partially, within the main memory 704, static memory 706, and/or within the processor 702 during execution thereof by the computer system 700, the main memory 704, static memory 706 and the processor 702 also constituting machine-readable media. The instructions 724 may further be transmitted or received over a network 726 via the network interface device 720.

While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium, such as a storage device, that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical media, and magnetic media.

Thus, method and system for generating, distributing and redeeming deals were described. Although the present invention has been described with reference to specific example embodiments, it will be evident that various modifications and changes may be made to these embodiments without departing from the broader spirit and scope of the invention. The various modules and/or engines described herein may be implemented in hardware, software, or a combination of these. Accordingly, the specification and drawings are to be regarded in an illustrative rather than a restrictive sense.

According to various embodiments, sellers may create and distribute an offer (e.g., daily deal) for a product or service to multiple users in a strategically targeted area. Also, buyers may redeem a voucher of the product or service using his mobile device without the need for other hardware, such as a point-of-sale (POS) system or a personal computer on the sellers' sides, reducing inconvenience incurred by printing out the voucher in a paper, for example. The market availability of the sellers who lack an online presence, such as mobile vendors (e.g., food truck owners), or experience (temporary) technical breakdown of their existing hardware, may be enhanced.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. An apparatus comprising:
one or more processors to execute a deal management e module, the deal management module configured to:
receive, from a mobile device corresponding to a first user, an indication to purchase an offer for a product or service provided by a second user, the offer being previously to the user via the mobile device;
transmit a voucher for the product or service to the mobile device in response to the indication to purchase the offer;
receive a request to redeem the voucher from the mobile device, the request including an identification code;
compare the identification code received from the mobile device with a shop identification code identifying the second user; and
provide an indication of redemption of the voucher to a computing device corresponding to the second user based on determining that the identification code received from the mobile device matches the shop identification code.

2. The apparatus of claim 1, the deal management module is configured to:
receive, from the computing device, information describing terms of the offer for the product or service;
generate the offer based at least n part on the information describing the terms; and
distribute the offer to a plurality of mobile devices including the mobile device based on determining that the mobile devices are located within a specified geographical zone.

3. The apparatus of claim 2, the deal management module is configured to:
receive, from the computing device, first zone information identifying a first geographical area, and second zone information identifying a second geographical area;
generate an exclusion zone and an inclusion zone based at least in part on the first zone information and the second zone information, respectively, such that the exclusion zone overlaps at least a portion of the inclusion zone; and
designate, as the specified geographical zone, an area located outside the exclusion zone and within the inclusion zone.

4. The apparatus of claim 1, wherein the deal management module is configured to:
identify a geographical location of the mobile device based at least in part on location information received from the mobile device; and
provide the mobile device with a plurality of offers including the offer available in the geographical location.

5. The apparatus of claim 4, wherein the deal management module is configured to:
cause the plurality of offers to be presented, via the mobile device, as sorted based at least in part on a category of the product or service associated with a corresponding offer of the offers, or a distance between the geographical location of the mobile device and a physical business location that provides the corresponding offer.

6. The apparatus of claim 1, wherein the deal management module is configured to:
assign, as the shop identification code, a unique identification number associated with a physical business location operated by the second user.

7. The apparatus of claim 1, wherein the deal management module is configured to:
trigger, based on matching the identification code received from the mobile device to the shop identification code, transfer of a fee associated with the offer from a first account corresponding to the first user to a second account corresponding to the second user.

8. The apparatus of claim 7, wherein the deal management module is configured to:
trigger the transfer of the fee associated with the offer by communicating transaction details to a third-party payment system.

9. The apparatus of claim 1, wherein the deal management module is configured to:
invalidate the voucher upon expiration of a time period specified in the offer.

10. The apparatus of claim 1, wherein the deal management module is configured to:
provide the computing device with status information for one or more vouchers including the voucher for a corresponding offer generated by the second user, the status information including at least one of first information indicating whether the voucher has been redeemed, or second information indicating when the voucher was redeemed via the mobile device of a user who purchased the offer.

11. A method comprising:
receiving, from a mobile device corresponding to a first user, an indication to purchase an offer for a product or service provided by a second user, the offer being previously presented to the user via the mobile device;
transmitting a voucher for the product or service to the mobile device in response to the indication to purchase the offer;
receiving a request to redeem the voucher from the mobile device, the request including an identification code;
comparing the identification code received from the mobile device with a shop identification code identifying the second user; and
providing, using one or more processors, an indication of redemption of the voucher to a computing device corresponding to the second user based on determining that the identification code received from the mobile device matches the shop identification code.

12. The method of claim 11, further comprising:
receiving, from the computing device, information describing terms of the offer for the product or service;
generating the offer based at least in part on the information describing the terms; and
distributing the offer to a plurality of mobil, devices including the mobile device based on determining that the mobile devices are located within a specified geographical zone.

13. The method of claim 12, wherein the distributing comprises:
receiving, from the computing device, first zone information identifying a first geographical area, and second zone information identifying a second geographical area;
generating an exclusion zone and an inclusion zone based at least in part on the first zone information and the second zone information, respectively, such that the exclusion zone overlaps at least a portion of the inclusion zone; and
designating, as the specified geographical zone, an area located outside the exclusion zone and within the inclusion zone.

14. The method of claim 13, wherein the distributing comprises:
refraining from distributing the offer to one or more of the plurality of mobile devices located within both the exclusion zone and the inclusion zone.

15. The method of claim 11, wherein the receiving the request to redeem comprises:
receiving, as the identification code, a non-encrypted string of at least one of a letter, a number or a symbol from the mobile device.

16. The method of claim 11, wherein the receiving the request to redeem comprises:
receiving, as the identification code, information captured via at least one of a bar code reader, a QR (Quick Response) code reader or a REID (Radio-Frequency Identification) reader associated with the mobile device.

17. The method of claim 11, wherein the comparing comprises:
identifying that the shop identification code has been assigned to a vendor whose physical business location does not have a fixed geographical address.

18. The method of claim 11, wherein the comparing comprises:
identifying that the shop identification code matches a mobile phone number of the second user.

19. The method of claim 11, further comprising:
triggering, based on matching the identification code received from the mobile device to the shop identification code, transfer of a fee associated with the offer from a first account corresponding to the first user to a second account corresponding to the second user, at least one of the first and second account being associated with a third party payment system.

20. A machinereadahle storage device storing instructions that, when executed by one or more processors, cause the one or more processors to perform operations comprising:
receiving, from a mobile device corresponding to a first user, an indication to purchase an offer for a product or service provided by a second user, the offer being previously presented to the first user via the mobile device;
transmitting a voucher for the product or service to the mobile device in response to the indication of purchase of the offer;
receiving a request to redeem the voucher from the mobile device, the request including an identification code;
comparing the identification code received from the mobile device with a shop identification code identifying the second user; and
providing an indication of redemption of the voucher to a computing device corresponding to the second user based on determining that the identification code received from the mobile device matches the shop identification code.
